(19) United States
(12) Patent Application Publication
(10) Pub. No.: US 2022/0266653 A9
(43) Pub. Date: Aug. 25, 2022

(54) MODULAR LED HEADLAMP ASSEMBLY WITH HEATING ELEMENTS FOR AUTOMATICALLY CLEARING WATER CONTAMINATION

(71) Applicants: Krzysztof P. Michalowski, Livonia, MI (US); Oliver Ashak, Rochester Hills, MI (US); Benedetto P. Dicicco, Rochester Hills, MI (US); Leland L. Decker, Sterling Heights, MI (US); Kyle Lucas, Livonia, MI (US)

(72) Inventors: Krzysztof P. Michalowski, Livonia, MI (US); Oliver Ashak, Rochester Hills, MI (US); Benedetto P. Dicicco, Rochester Hills, MI (US); Leland L. Decker, Sterling Heights, MI (US); Kyle Lucas, Livonia, MI (US)

(21) Appl. No.: 17/005,462

(22) Filed: Aug. 28, 2020

Related U.S. Application Data
(60) Provisional application No. 62/893,431, filed on Aug. 29, 2019.

(51) Int. Cl. B60H 1/00; F21S 41/143; F21S 45/60; F21V 29/90

(52) U.S. Cl. CPC B60H 1/00785; F21S 41/143; F21S 45/60; F21V 29/90; B60H 1/00764; F21Y 2115/10

(57) ABSTRACT

A vehicle comprising an LED headlamp including a lens and an LED light source. A heating element is provided at the lens. A control module is in communication with the heating element. A temperature sensor that is configured to generate a signal indicative of an outside temperature is in communication with the control module, and a speed sensor that is configured to generate a signal indicative of a vehicle speed is in communication with the control module. Upon receipt by the control module of the signal indicative of the outside temperature that is less than a predetermined temperature and upon receipt by the control module of the signal indicative of the vehicle speed that is greater than a predetermined vehicle speed, the control module is configured to activate the heating element.

### CROSS-REFERENCE TO RELATED APPLICATIONS

This application claims priority to U.S. Provisional Patent Application No. 62/893,431 filed on Aug. 29, 2019. The disclosure of which is incorporated herein by reference in its entirety

### FIELD

The present invention relates to automotive vehicles having light emitting diode headlamps, referred to herein as LED headlamps, and automatically clearing water from the LED headlamps.

### BACKGROUND

LED headlamps compared to other type of headlamps don't generate sufficient heat when low or high beams are turned on to clear water (e.g., condensation) from the headlamps. This can result in snow and ice accumulation on the outer lens surface of the LED headlamps which results in reduction of the optical light transmission through the plastic (polycarbonate) lens of the headlamp. Aftermarket headlamps are available that have technology that reduce ice and snow accumulation on the lens using heating elements on the lens, a grid of heating elements in some cases, and a microprocessor inside a lamp, which activates the heating elements on the lens at startup and when outside temperature meets predetermine conditions. This technology is less effective at clearing water from the headlamps at low temperatures and higher driving speed due to wind chill effect. In this condition, the cooling effect is much stronger than the heating power of the heating elements on the lens. In addition, a drop of the output voltage of the battery in the vehicle may result in a significant reduction of the heating power provided to the heating grid with a resultant reduction of the heating provided by the heating elements. In many cases, the heating elements are powered when it is not necessary to have them powered.

There are several known methods of clearing ice/snow from LED headlamps.

A LED headlamp can have heating elements on the lens. The heating elements can be affixed to the lens in a number of different ways. Ultrasonic wire laying technology developed by Ruhlamat can be used to lay the heating elements on the lens. A 3D grid of heating elements can be printed on the lens using aerosol jet technology developed by Optomec. Inkjet printing can be used to print the heating elements on the lens.

Heating element lines (i.e., a grid) can be printed on a polycarbonate film utilizing screen printing technology. In next step, the film with grid is preformed and trimmed to the shape of the lens. The preformed piece is then positioned in a mold prior to plastic injection molding the lens. During molding, the plastic flows around the polycarbonate film with the grid on it to encapsulate it and connect with it some way. The finished product is a lens with the polycarbonate film with the heating element grid printed on it.

A LED headlamp can have a fan with a heater inside the housing of the LED headlamp (although this presents a difficulty in packaging the fan and heater inside the housing of the LED headlamp). A LED headlamp can have an infra-red (IR) emitter that heats the lens of the LED headlamp only in a localized area. A heated washer fluid can be sprayed on the lens of a LED headlamp.

Aftermarket headlamps offer technology to reduce ice and snow accumulation on the lens using a grid of heating elements as discussed above and a microprocessor inside the housing of the headlamp, which activates the grid on the lens at startup and when outside temperature meets predetermined conditions, in most cases below 50 F. In some cases, the headlamps also have a thermistor to prevent the heating elements from overheating at higher operating temperature. This technology does not have a switch or sensor to turn off the heating elements when driving at low temperature when this heating method and technology is less effective, resulting in a waste of energy.

These known approaches suffer from deficiencies. The decision to activate/deactivate the heating elements in the headlamps is made based on only two parameters: outside temperature and engine mode (on/off). The headlamps don't communicate with the vehicles body control module which collects much more information. Defrosters in the headlamp are active most of the time, although water contamination on the lens may only occur infrequently, resulting in a waste of energy. Headlamps utilizing these known approaches don't help in meeting Corporate Average Fuel Economy (CAFE) targets.

### SUMMARY

According to a first aspect of the present disclosure, there is provided a vehicle that includes an LED headlamp including a lens and an LED light source; a heating element provided at the lens; a control module in communication with the heating element; a temperature sensor configured to generate a signal indicative of an outside temperature in communication with the control module; and a speed sensor configured to generate a signal indicative of a vehicle speed in communication with the control module; wherein upon receipt by the control module of the signal indicative of the outside temperature that is less than a predetermined temperature and upon receipt by the control module of the signal indicative of the vehicle speed that is greater than a predetermined vehicle speed, the control module is configured to activate the heating element.

In the vehicle according to the first aspect, the speed sensor may be a wheel speed sensor.

In addition, according to the first aspect, the vehicle may further include a rain sensor configured to generate a signal indicative of whether the vehicle is being subjected to precipitation, and upon receipt by the control module of the signal indicative of the outside temperature that is less than a predetermined temperature and upon receipt by the control module of the signal indicative of the vehicle being subjected to precipitation, the control module is configured to activate the heating element.

In the vehicle according to the first aspect, the heating element may include a plurality of conductive traces. The plurality of conductive traces may be positioned about an entire surface area of the lens. In addition, the plurality of conductive traces may be disposed in a horizontal grid pattern.

In the vehicle according to the first aspect, the control module may include a DC-to-DC converter for suppling a DC voltage to the heating element.

In the vehicle according to the first aspect, the vehicle may further include a rear defroster in communication with the control module, and upon receipt of a signal from the rear defroster than the rear defroster has been activated, the control module is configured to activate the heating element.

In the vehicle according to the first aspect, the predetermined temperature may be 50 degrees F.

Lastly, in the vehicle according to the first aspect, the predetermined vehicle speed may be 40 mph.

According to a second aspect of the present disclosure, there is provided a method of controlling a LED headlamp of a vehicle that includes a lens and a heating element provided at the lens. The method comprises determining whether the vehicle has been turned on; after determining that the vehicle has been turned on, determining whether an outside temperature is less than a predetermined temperature; after determining that the outside temperature is less than the predetermined temperature, determining whether a vehicle speed is greater than a predetermined vehicle speed; and activating the heating element if the outside temperature is less than the predetermined temperature and the vehicle speed is greater than the predetermined vehicle speed.

In the method according to the second aspect, the method may further include determining whether the vehicle is being subjected to precipitation, and activating the heating element if the vehicle is being subjected to precipitation.

Lastly, in the method according to the second aspect, the method may further include determining whether a vehicle rear defroster has been activated, and activating the heating element if the vehicle rear defroster has been activated.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a perspective view of a vehicle including LED headlamps that each have a heating element according to a principle of the present disclosure;

FIG. 2 is a schematic representation illustrating communication between the LED headlamps and various sensors and control modules of the vehicle illustrated in FIG. 1;

FIG. 3 is a schematic representation of an example LED headlamp including a heating element according to a principle of the present disclosure;

FIG. 4 is schematic representation of a control logic used to control the heating element of the LED headlamp illustrated in FIG. 3; and

FIGS. 5A to 5C are schematic representations of various orientations of the traces that form the heating element of the LED headlamp illustrated in FIG. 3.

### DETAILED DESCRIPTION OF THE INVENTION

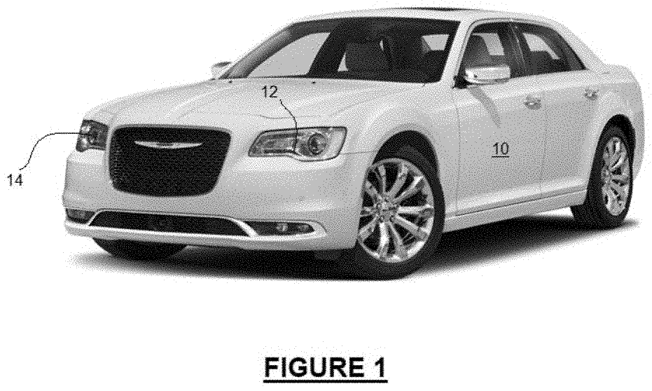

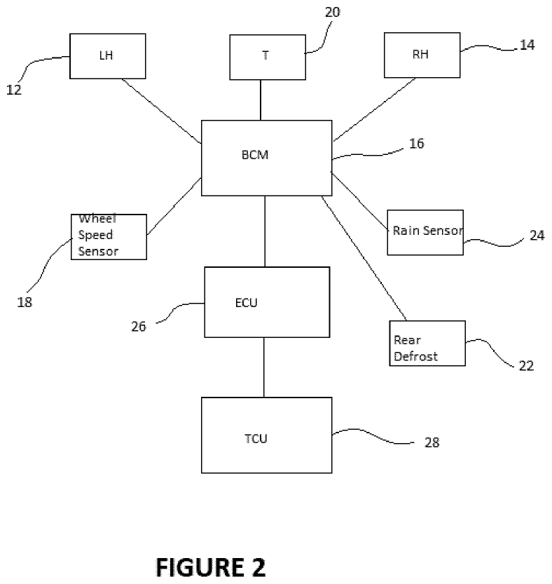

With reference to FIGS. 1 and 2, in accordance with an aspect of the present disclosure, a vehicle 10 has a system for clearing water contamination from LED headlamps 12 and 14. As best shown in FIG. 2, vehicle 10 includes a body control module (BCM) 16 and a plurality of sensors that are configured to, for example, sense vehicle speed (e.g., wheel speed sensor 18, which may be attached to one of the wheels 19 of vehicle 10), outside temperature (temperature sensor 20) and rear window defroster 22 status (on/off). The vehicle 10 may also include a rain sensor 24 that, for example, may be used to detect rain/freezing rain that may result in ice/water accumulation of the LED headlamps 12 and 14, or detect whether vehicle 10 is undergoing a wash that may result in condensation in or on the LED headlamps 12 and 14. It should be understood that information from additional types of sensors can also be used in determining when to activate the heating elements. Each of sensors 18, 20, 22, and 24 may communicate directly with BCM 16, which in turn may communicate with vehicle electronic control unit (ECU) 26 and transmission control unit (TCU) 28.

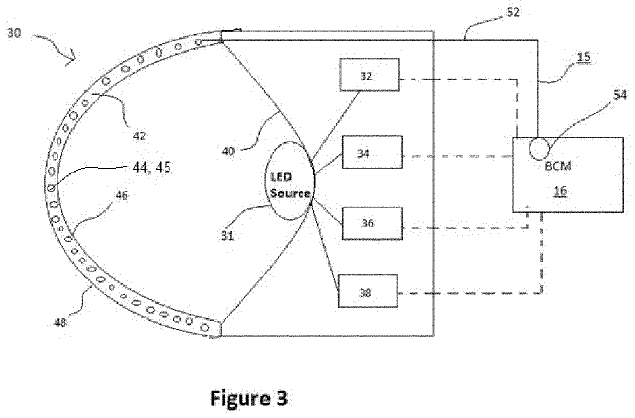

As best shown in FIG. 3, the LED headlamps 12, 14 are each a modular headlamp assembly 30 that includes a LED light source 31 that communicates with low beam headlamp module 32, a high beam headlamp module 34, a daytime running light module 36, and a front turn/parking lamp module 38, which in turn control an intensity and/or color of the light emitted by LED light source 31. The low beam headlamp module 32 and the high beam headlamp module 34 may be supported by a reflector carrier 40. The headlamps 12, 14 include a thermoplastic polycarbonate (PC) lens 42 with embedded thermally conductive heating elements 44 between an inner lens surface 46 and an outer lens surface 48. Alternatively, heating elements 44 may be located on or embedded at inner lens surface 46. The heating elements 44 may, for example, be wires, traces including printed traces, or the like. The heating elements 44 may be, for example, formed from materials such as copper, silver, lead free silver ceramic, carbon, nichrome, PTC, a mixture of metal and resin such as used in rear window defrosters, or the like.

Heating elements 44 of the lens 42 are connected via a headlamp main connector 50 with the BCM 16 which activates or deactivates the heating elements 44 based on the predetermined conditions developed to predict possibility of icing or snow accumulation on the outer lens surface 48 or water condensation on the inner lens surface 46. BCM 16 collects and analyzes information from the sensors 18-24, checks if predetermined conditions (discussed below) are met and if they are, BCM 16 then activates heating elements 44 in the headlamps 12, 14 to clear ice, snow or water from outer lens surface 48 or inner lens surface 46. BCM 16 is configured to react to outside temperature, vehicle speed changes, and the mode (on/off) of rear defroster 22 on a real-time basis with no action required by the driver. Firstly, anytime a driver activates a rear window defroster 22 of the vehicle 10 to remove condensation or snow/ice, a signal indicative of rear window defroster 22 being turned on may be sent to BCM 16, which will then automatically activate the heating elements 44 of the headlamps 12, 14 as the headlamps 12, 14 may be experiencing the same conditions that required the driver to activate the rear window defroster 22.

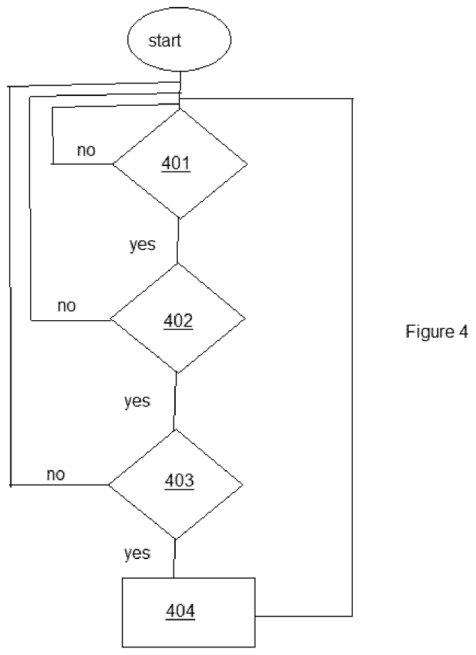

Secondly, BCM 16 is configured to activate the heating elements 44 when the outside temperature is below a predetermined temperature and the speed of the vehicle 10 is above a predetermined speed. FIG. 4 is a flow chart of a control logic for such a process. In an aspect, the predetermined temperature is 50 degrees Fahrenheit and the predetermined speed is 40 mph. It should be understood that other temperatures and speeds can be used for the predetermined temperature and speed and are illustratively determined heuristically. Regardless, as shown in FIG. 4, at step 401 BCM 16 is configured to determine an engine mode (i.e., on or off) of the vehicle 10. This information is typically relayed by ECU 26 to BCM 16 via a CAN bus (not shown) or the like, or any other communication method known to one skilled in the art. If the engine is determined to be on, the control logic proceeds to step 402. If the engine is determined to be off, the control logic proceeds back to step 401.

After determining the engine mode is “on” at step 401, BCM 16 is configured at step 402 to determine an outside temperature, which is done upon receipt of a signal indicative of the outside temperature from temperature sensor 20. If the signal received by BCM 16 from temperature sensor 20 is indicative of a temperature less than 50 degrees F., the control logic proceeds to step 403. If the temperature is greater than 50 degrees F., the control logic proceeds back to step 401.

After determining that the outside temperature is less than 50 degrees F., BCM 16 is configured at step 403 to determine a speed of the vehicle, which is done upon receipt of a signal indicative of the vehicle speed from wheel speed sensor 18 or upon receipt of a signal indicative of vehicle speed from TCU 28 via ECU 26. If the signal received by BCM 16 from wheel speed sensor 18, TCU 28, or ECU 26 is indicative of a vehicle speed greater than 40 mph, the control logic proceeds to step 404 where heating elements 44 are energized. If the vehicle speeds is less than 40 mph, the control logic proceeds back to step 401. In this manner, the heating elements 44 are only turned on at step 404 if the outside temperature is below a predetermined threshold (i.e., less than 50 degrees F.) and the vehicle speed is greater than a predetermined threshold (i.e., greater than 40 mph). This is done because the wind chill experienced by headlamps 12, 14 at greater speeds in lower temperatures can increase the likelihood of water freezing on headlamps 12, 14 or condensation developing on headlamps 12, 14. Energy is not wasted in energizing the heating elements 44 when the temperature is low, but the vehicle is not operating in a state (i.e., in a state of movement at speeds greater than 40 mph) that may require heating the lens 42 of the headlamps 12, 14.

Modifications to the above-noted control logic include replacing the step 403 of determining the vehicle speed with a step of determining whether the vehicle 10 is being subjected to precipitation (rain/snow) or being washed. This information is typically provided to BCM from rain sensor 24. Alternatively, this step may be added as an additional step between step 403 and step 404.

While the heating element 44 is typically activated or energized when the predetermined conditions (e.g., temperature, vehicle speed, and precipitation) are being met, it should be understood that the heating element 44 is not necessarily continuously activated or energized during the entirety of the time period that the predetermined conditions are being met. For example, the heating element 44 can be activated or energized by BCM 16 for a period of three minutes, five minutes, ten minutes, or more. If the predetermined conditions persist, the BCM 16 can periodically reactivate the heating elements 44 after a period of, for example, five minutes, ten minutes, or fifteen minutes. In this manner, the energy required to activate heating elements 44 is not unnecessarily wasted by continuously operating heating elements 44.

BCM 16 may include a DC-to-DC converter 54 integrated therewith (FIG. 3) that supplies a constant 13.8 VDC to the heating elements 44 on the lenses 42 of both of the LED headlamps 12, 14, of the to maintain the same heating power despite an output voltage drop of the vehicle battery. BCM 16 may automatically activate the heating elements 44 at startup of the vehicle 10 if one the predetermined conditions is met (e.g., temperatures below 32 degrees F., or rain sensor 24 detecting precipitation). A PTC type thermistor (not shown) in each LED headlamp 12, 14 protects the heating elements 44 from overheating.

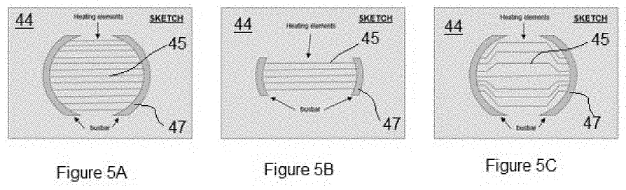

The heating elements 44 on the lens 42 can cover the whole lens 42 surface (small headlamps) as shown in FIGS. 3 and 5A or the low and high beam area on larger headlamps 12, 14 as shown in FIG. 5B. In an aspect, the heating elements 44 are traces 45 that extend between a pair of busbars 47, and have the following parameters and orientation on the lens 42 which were found to provide enhanced deicing and photometric performance:

orientation of heating element traces 45: horizontal (FIGS. 5A-5C);

width of the heating element traces 45: 0.10 mm to 0.5 mm;

spacing between adjacent heating element traces 45: 6 mm to 8 mm

It should be understood that the traces 45 of the heating elements 44 can have different lengths. However, for uniform heating and deicing, differences in lengths of the traces 45 are compensated by thickness changes of each trace 45 so that the all the heating element traces 45 have the same electrical resistance. In this regard, if all the traces 45 are the same length as shown in FIG. 5C, each trace 45 can have the same thickness. In an aspect, the heating elements 44 are sized so that the heating power of the traces 45 is 0.8-1.6 watts/inch².

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vehicle comprising:
an LED headlamp including a lens and an LED light source;
a heating element provided at the lens;
a control module in communication with the heating element;
a temperature sensor configured to generate a signal indicative of an outside temperature in communication with the control module; and
a speed sensor configured to generate a signal indicative of a vehicle speed in communication with the control module;
wherein upon receipt by the control module of the signal indicative of the outside temperature that is less than a predetermined temperature and upon receipt by the control module of the signal indicative of the vehicle speed that is greater than a predetermined vehicle speed, the control module is configured to activate the heating element.

2. The vehicle of claim 1, wherein the speed sensor is a wheel speed sensor.

3. The vehicle of claim 1, further comprising a rain sensor configured to generate a signal indicative of whether the vehicle is being subjected to precipitation, and upon receipt by the control module of the signal indicative of the outside temperature that is less than a predetermined temperature and upon receipt by the control module of the signal indicative of the vehicle being subjected to precipitation, the control module is configured to activate the heating element.

4. The vehicle of claim 1, wherein the heating element includes a plurality of conductive traces.

5. The vehicle of claim 4, wherein the plurality of conductive traces are positioned about an entire surface area of the lens.

6. The vehicle of claim 4, wherein the plurality of conductive traces are disposed in a horizontal grid pattern.

7. The vehicle of claim 1, wherein the control module includes a DC-to-DC converter for suppling a DC voltage to the heating element.

8. The vehicle of claim 1, further comprising a rear defroster in communication with the control module, and upon receipt of a signal from the rear defroster than the rear defroster has been activated, the control module is configured to activate the heating element.

9. The vehicle of claim 1, wherein the predetermined temperature is 50 degrees F.

10. The vehicle of claim 1, wherein the predetermined vehicle speed is 40 mph.

11. A method of controlling a LED headlamp of a vehicle that includes a lens and a heating element provided at the lens, the method comprising:
determining whether the vehicle has been turned on;
after determining that the vehicle has been turned on, determining whether an outside temperature is less than a predetermined temperature;
after determining that the outside temperature is less than the predetermined temperature, determining whether a vehicle speed is greater than a predetermined vehicle speed; and
activating the heating element if the outside temperature is less than the predetermined temperature and the vehicle speed is greater than the predetermined vehicle speed.

12. The method of claim 11, further comprising determining whether the vehicle is being subjected to precipitation, and activating the heating element if the vehicle is being subjected to precipitation.

13. The method of claim 11, further comprising determining whether a vehicle rear defroster has been activated, and activating the heating element if the vehicle rear defroster has been activated.
